(19) United States
(12) Patent Application Publication
(10) Pub. No.: US 2020/0150032 A1
(43) Pub. Date: May 14, 2020

(54) TERAHERTZ SYSTEMS AND METHODS FOR MATERIALS IMAGING AND ANALYSIS

(71) Applicant: THE REGENTS OF THE UNIVERSITY OF CALIFORNIA, Oakland, CA (US)

(72) Inventors: Mau-Chung Frank Chang, Los Angeles, CA (US); Richard Al Hadi, Los Angeles, CA (US); Yan Zhao, Woodland Hills, CA (US)

(73) Assignee: THE REGENTS OF THE UNIVERSITY OF CALIFORNIA, Oakland, CA (US)

(21) Appl. No.: 16/666,759

(22) Filed: Oct. 29, 2019

Related U.S. Application Data
(63) Continuation of application No. PCT/US2018/030993, filed on May 3, 2018.
(60) Provisional application No. 62/500,627, filed on May 3, 2017.
(60) Provisional application No. 62/524,254, filed on Jun. 23, 2017.

(51) Int. Cl. G01N 21/3563; G01N 21/3581; G01N 21/86; G01N 21/89; G01N 21/892

(52) U.S. Cl. CPC G01N 21/3563; G01N 21/3581; G01N 21/892; G01N 21/8901; G01N 21/86

(57) ABSTRACT

An imaging device and method for evaluating and/or imaging material or chemical constituents of a sample. In one configuration, the imaging device includes a scanner having a terahertz wave transmitter configured to determine the amount of superabsorbent polymer (SAP) in the core of disposable hygiene product such as baby diapers, adult diapers and feminine hygiene pads, during the fabrication process.

### CROSS-REFERENCE TO RELATED APPLICATIONS

This application claims priority to, and is a 35 U.S.C. § 111(a) continuation of, PCT international application No. PCT/US2018/030993 filed on May 3, 2018, incorporated herein by reference in its entirety, which claims priority to, and the benefit of, U.S. provisional patent application Ser. No. 62/500,627 filed on May 3, 2017, incorporated herein by reference in its entirety, and which also claims priority to, and the benefit of, U.S. provisional patent application Ser. No. 62/524,254 filed on Jun. 23, 2017, incorporated herein by reference in its entirety. Priority is claimed to each of the foregoing applications.

The above-referenced PCT international application was published as PCT International Publication No. WO 2018/204724 A1 on Nov. 8, 2018, which publication is incorporated herein by reference in its entirety.

### STATEMENT REGARDING FEDERALLY SPONSORED

RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to material imaging, and more particularly to an imaging device and method for evaluating material or chemical constituents of a sample material.

### 2. Background Discussion

Superabsorbent polymers (SAP's) are materials that absorb and retain extremely large amounts of a liquid relative to their own mass. Determining the amount and/or distribution of SAP within products that utilize such materials is crucial for both controlling the total amount of SAP and its cost, and the quality of each product (e.g., diaper or like disposable hygiene product) to properly absorb liquids when used.

The current state of the art devices generally employ X-ray scanners, capacitive and inductive detection methods, ultra-sound scanners, and the like devices. X-ray scanner radiation regulations make such scanners difficult to deploy. Furthermore, capacitive, inductive and ultra-sound sensing devices lack precision.

Existing devices are generally based on one or two-point sources and a detector array, so the whole detector array is only illuminated by one or two sources, suffering from low signal-to-noise ratio. Such configurations force the point source to be installed a certain (generally large) distance away from detector array to make sure its radiation range covers all detector sensors. This makes the whole system very bulky. Other devices use a detector array in a single chip integration configuration that involves a very large lens to support large scanning width, making the system even more bulky.

### BRIEF SUMMARY

An aspect of the technology of this disclosure is an imaging device and method for evaluating and/or imaging material or chemical constituents of a sample. In one exemplary embodiment, the imaging device comprises a scanner having a terahertz wave transmitter configured to determine the amount of superabsorbent polymer (SAP) in the core of disposable hygiene product such as baby diapers, adult diapers and feminine hygiene pads, during the fabrication process.

In a preferred embodiment, the scanner comprises a linear array of sources and corresponding detectors. Furthermore, each source and detector comprises a chip that is assembled in a discrete form (or module, or package). Because each source/detector pair of the linear array may be configured to completely or partially rely on respective dedicated micro-lens optics, no large lens needed for whole array, enabling a compact scanner body while still supporting a wide scanning width. In contrast, a large lens usually has a comparable or larger dimension than the desired scanning width, and uses a longer distance between the source and detector due to the according focal length.

In another preferred embodiment, the detector sensors of the array of the terahertz wave scanner of the technology of the present description are configured to operate in parallel, thus supporting high-speed scanning and avoiding the need for raster scanning.

Finally, because each detector sensor is illuminated by a dedicated source a much better signal-to-noise ratio performance (i.e., better image contrast) is achieved using the system and methods of the technology of the present description.

Further aspects of the technology of the present description will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A and FIG. 1B show top and side views of a disposable hygiene product on a fabrication line after sealing with opaque polyester and polyethylene sheets.

FIG. 2A shows a perspective view of a terahertz imaging module of the technology of the present description in transmission mode.

FIG. 2B shows a side view of the terahertz imaging module of FIG. 2A.

FIG. 3 shows a perspective view of a terahertz imaging module with a transmission scenario utilizing a reflective plate according to an embodiment of the present technology.

FIG. 4 shows a cross-sectional view of a first embodiment of the terahertz imaging module in accordance with the technology of the present description.

FIG. 5 shows a cross-sectional view of a second embodiment of the terahertz imaging module having collimating/focusing discrete lenses.

FIG. 6 shows a cross-sectional view of a third embodiment of the terahertz imaging module having large lenses for a wider illumination area.

FIG. 7 shows a cross-sectional view of a fourth embodiment of the terahertz imaging module having horizontal cylindrical lenses.

FIG. 8 shows a cross-sectional view of an alternative embodiment of the terahertz imaging module of FIG. 7 with source/detector chips mounted directly to the horizontal cylindrical lenses.

FIG. 9 shows a cross-sectional view of an alternative source array comprising a dish configuration in accordance with the technology of the present description.

FIG. 10A shows an array of sources/detectors disposed as a linear array.

FIG. 10B shows an alternative array of sources/detectors disposed as a pair of interleaved linear arrays.

FIG. 10C shows an alternative array of sources/detectors disposed as a series of n interleaved linear arrays.

FIG. 11A shows a schematic diagram of an individual source/detector in the form of a single pixel.

FIG. 11B shows a schematic diagram of an individual source/detector having two pixels.

FIG. 11C shows a schematic diagram of an individual source/detector having n pixels.

FIG. 12 shows a block diagram showing configuration and process flow for SAP using the imaging device of the technology of the present description.

FIG. 13 shows a block diagram showing configuration and process flow for material processing using the imaging device of the technology of the present description.

FIG. 14 shows a schematic flow diagram for a material processing algorithm that may be implemented as programming for the systems of FIG. 12 or FIG. 13.

### DETAILED DESCRIPTION

Described herein is an imaging device and method for imaging/evaluating an amount or distribution of a composition within a sample material. In one embodiment, the imaging device and method are configured for imaging/evaluating an amount or distribution of superabsorbent polymer (SAP) in the core of disposable hygiene product such as baby diapers, adult diapers and feminine hygiene pads during the fabrication process.

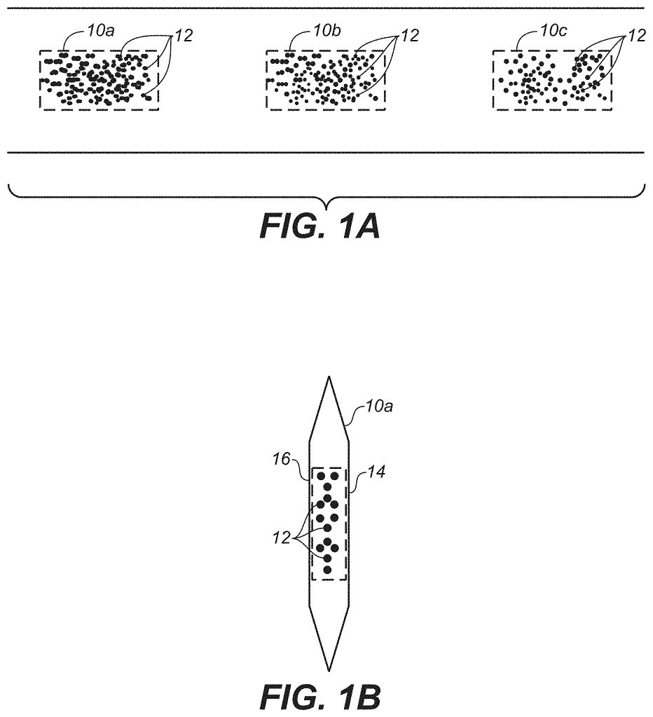

FIG. 1A and FIG. 1B show top and side views of an exemplary configuration for an imaging device and method for evaluating/imaging a disposable hygiene product on a fabrication line. During the fabrication of an exemplary product instance 10a as illustrated in material FIG. 1B, a certain amount of SAP is mixed with fluff (collectively material 12), and is distributed over a certain area of the product, and then sealed between a polyester 16 and polyethylene 14 film. As seen in the top view of FIG. 1A, the distribution and amount of materials 12, and the distribution and amount of SAP amount per instances of the same product (e.g., 10a, 10b, and 10c, etc. for number 10n of product), may vary because of mechanical handling (extremely fast fabrication process up to 15 m/s speed or more), and/or fabrication process variations. The opacity of these materials makes it difficult or impossible to determine the amount of SAP and its distribution in the diaper core 12 at optical frequencies once sealed.

In contrast, signals at terahertz wave frequencies can penetrate most materials used in hygiene products. The wavelength at these frequencies can be adapted to the required resolution in the order of the terahertz wavelengths. The signals are partially absorbed by SAP and therefore, detecting the amount and distribution is possible. In a preferred embodiment, a terahertz wave scanner is used to detect the amount and distribution of SAP in the hygiene product core and its technical implementation.

For purposes of this description, a terahertz frequency range used by the terahertz wave scanner of the technology of the present description shall be defined as a wave ranging in frequency from about 30 GHz to about 10 THz. Preferably, the terahertz wave scanner operates at a frequency ranging from about 100 GHz to about 3 THz. More preferably, the terahertz wave scanner operates at a frequency ranging from about 300 GHz to about 1 THz. Accordingly, the terahertz wave scanner may operate beyond the typical bounds for a terahertz wave (0.3 T to 3 THz) and include other possible bands, including millimeter wave (30G to 0.3 THz), or microwave (3G to 30 GHz).

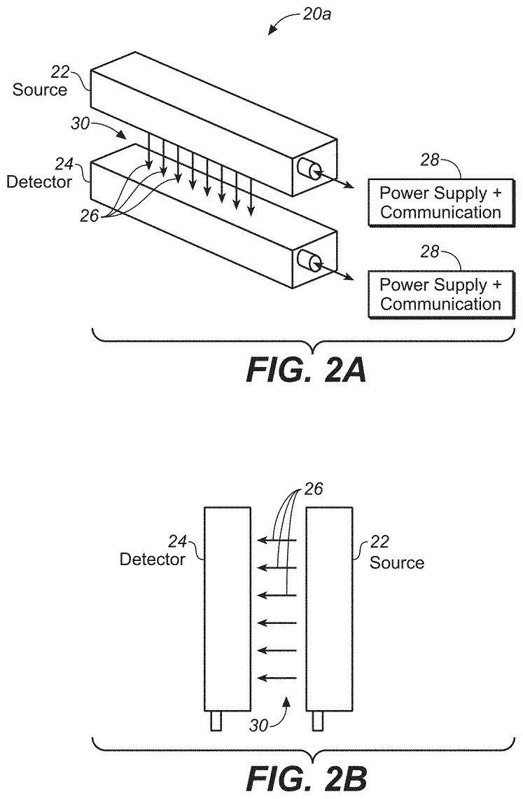

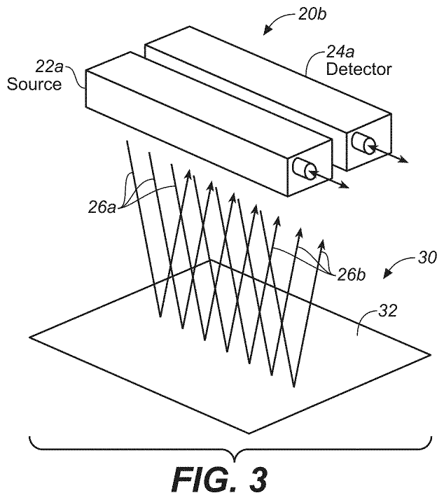

FIG. 2A through FIG. 3 show various embodiments of an imaging module configured to be mounted on the production chain to detect the content and distribution of constituents within a sample material (e.g., amount and distribution of SAP within a hygiene product).

FIG. 2A shows a perspective view of a terahertz imaging module 20a of the technology of the present description disposed over an imaging region 30 through which an assembly belt (not shown) or like device is used to sequentially deliver products (10a-10n, not shown). FIG. 2B shows a side view of the terahertz imaging module 20a of FIG. 2A. Imaging module 20a includes a source 22 comprising a linear array of sources/emitters each emitting dedicated terahertz waves (i.e., radiation patterns) 26 across imaging region 30 to be received by corresponding detectors/sensors in detector 24. Both source 22 and detector 24 are coupled to power supply and/or communication circuitry 28.

FIG. 3 shows a perspective view of an alternative terahertz imaging module 20b wherein both the source 22a and detector 24a are on the same side in relation to the imaging zone 30. Imaging module 20b incorporates a transmission scenario wherein emitted waves 26a pass through imaging region 30 and then are reflected off of reflective surface 32 and back across the imaging region 30 as reflected waves 26b to be received by dedicated detector chips within detector 24a.

Surface 32 is shown as a planar sheet in FIG. 3, however other shapes are contemplated, such as a concave, cylindrical, or other curvilinear reflective surface that focuses the emitted radiation back at the detector 24.

It is also appreciated that the imaging module may incorporate both transmission and reflection characteristics of the embodiments of FIG. 2 and FIG. 3. The detector 24 and source 22 may also be located in the same enclosure in FIG. 3.

In operation, sources 22 and detectors 24 are arranged in a linear fashion and a transmission mode image is produced. The source detector/pair 22/24 may be replaced with a transceiver or a retroactive detector as available in the art.

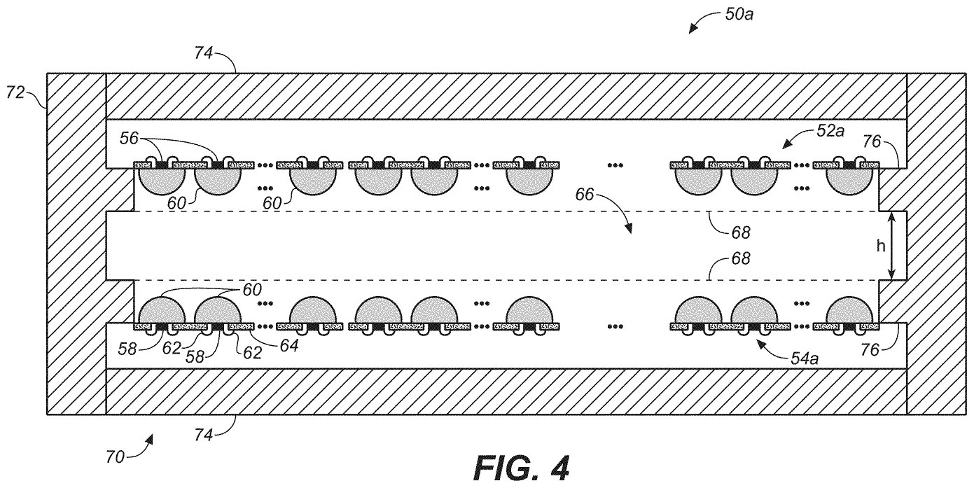

FIG. 4 shows a detailed cross-sectional view of a first embodiment of a terahertz imaging module 50a. Imaging module 50a comprises a single linear source array 52a comprising a plurality of source elements/emitters 56 disposed across a linear detector array 54a comprising a plurality of detector elements/sensors 58 from imaging region 66. Materials/samples to be detected (not shown) generally through the imaging region, in a direction perpendicular (into the page in FIG. 4 through FIG. 8) to the linear source/detector arrays 52a/54a in both the vertical direction and the horizontal alignment of the arrays. In one embodiment, the sample is delivered via a belt or like conveyance such that only the sample is delivered through the imaging region. Alternatively, a belt of appropriate material may pass through the imaging region with the sample.

While the source elements 56 are shown above the detector elements 58 in FIG. 4 through FIG. 6, it is appreciated that their respective positions may be reversed. Furthermore, source elements 56 may be interleaved with detector elements 58 within the same linear array. While source elements 56 are generally disposed to have a dedicated corresponding detector element 58, it is also appreciated that the source elements 56 may be configured with a wider and directed radiation pattern so as to be received by a designated set or plurality of detector elements 58.

Each source element 56 and detector element 58 is equipped with a high-dielectric lens 60 to collimate the beam (e.g., wave 26a) that is received by the respective dedicated detector element 58.

Optional protection layers 68 may be positioned on opposite sides of the imaging region 66 to prevent contamination of the sources/detectors from the sample materials. In a preferred embodiment, the protection layers comprise a polymeric material, such as Teflon or the like. The dedicated source/detector array as detailed in FIG. 4 through FIG. 6 allow for an imaging region having as small a height h as desired for the sample material to be imaged. In one exemplary embodiment for SAP detection in hygiene products, the height h of the imaging region 66 is approximately 1 inch.

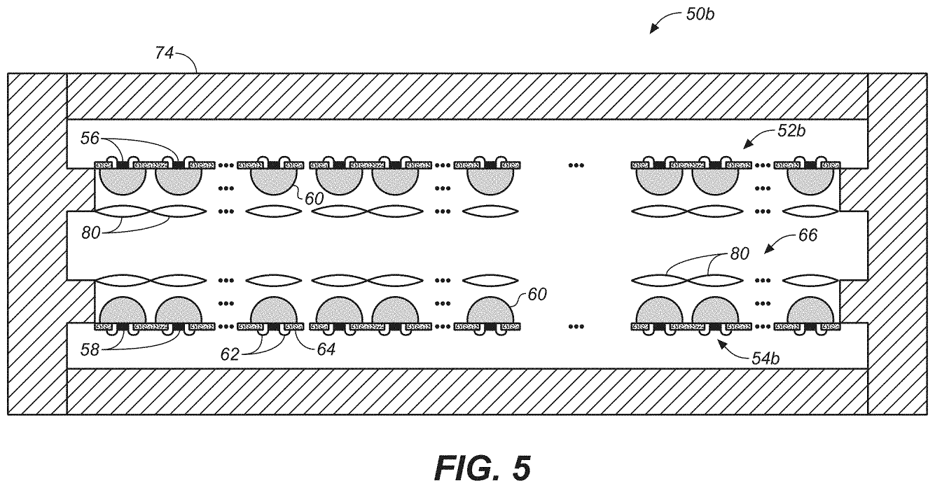

In the embodiments shown in FIG. 4 and FIG. 5, the emitter elements 56 and detector elements comprise chips that are wire bonded 62 to respective printed circuit boards (PCBs) 64. The imaging module 50a may also include a housing 70 comprising covers 74 and side walls 72 having protrusions 76 for securing PCBs 64. It is appreciated that PCBs 64 and wire bonding 62 are only one of many means of assembly contemplated, and that other assembly means available in the art may be employed.

FIG. 5 shows a cross-sectional view of an alternative terahertz imaging module 50b having collimating/focusing discrete lenses 80 disposed between dielectric lenses 60 of the source arrays 52b and detector arrays 54b and the imaging region 66. The collimating/focusing discrete lenses 80 may be positioned and sized so that they are dedicated to each source 56/detector 58 pair to increase the directivity of the beam the terahertz radiation wave from each source 56.

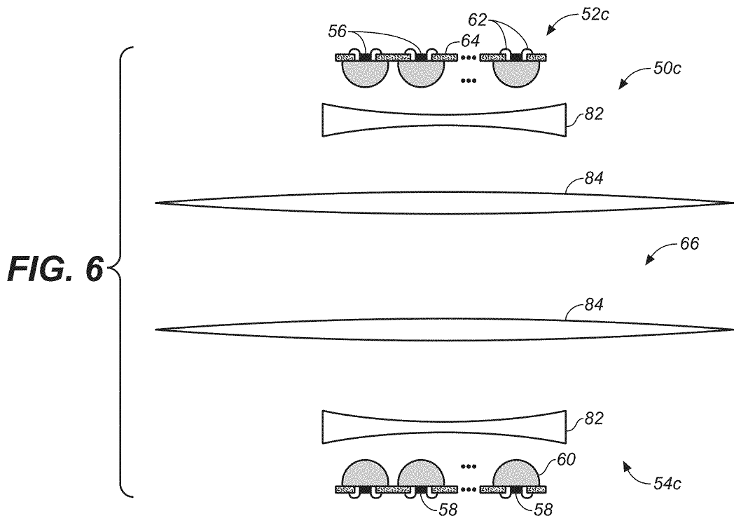

FIG. 6 shows a cross-sectional view of an alternative terahertz imaging module 50c having large concave 82 and convex 84 lenses disposed between dielectric lenses 60 of the source array 52c and detector array 54c and the imaging region 66 for a wider illumination/scanning area. Housing 70 is shown removed from the illustration of FIG. 6.

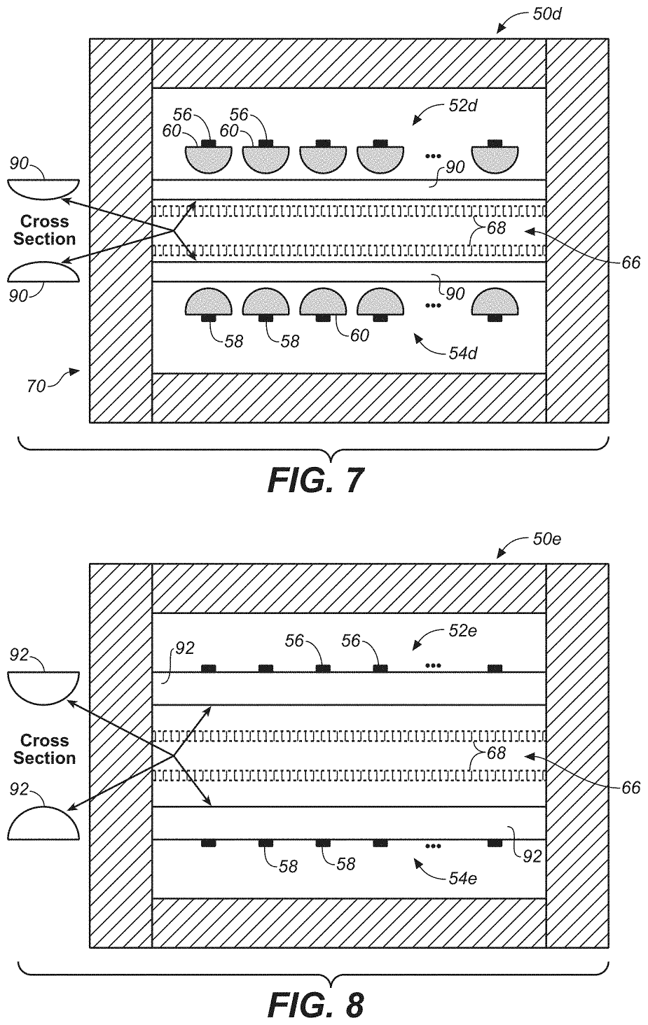

FIG. 7 shows a cross-sectional view of an alternative terahertz imaging module 50d having horizontal curvilinear lenses 90 between dielectric lenses 60 of the source array 52d and detector array 54d and the imaging region 66. As seen in FIG. 7, the horizontal curvilinear lens 90 has a length longer than the source/detector arrays, and a cross-sectional curvilinear profile (e.g., semi-circular other curvilinear profile such as elliptical, parabolic, arc segment, etc.) in a plane aligned in a direction of the emitted radiation pattern and perpendicular to the linear orientation of the array of transmitters and array of detectors. Attachment means (e.g., boards 64 and wire bonding 62) are shown removed from FIG. 7).

FIG. 8 shows a cross-sectional view of an alternative terahertz imaging module 50e having horizontal curvilinear lenses 92 between the source arrays 52e and detector arrays 54e and the imaging region 66. In this configuration, the source arrays 52e and detector arrays 54e are directly mounted on the flat surface of the horizontal curvilinear lenses 92. The horizontal curvilinear lens 92 has a length longer than the source/detector arrays, and a cross-sectional curvilinear profile (e.g., semi-circular other curvilinear profile such as elliptical, parabolic, arc segment, etc.) in a plane aligned in a direction of the emitted radiation pattern and perpendicular to the linear orientation of the array of transmitters and array of detectors.

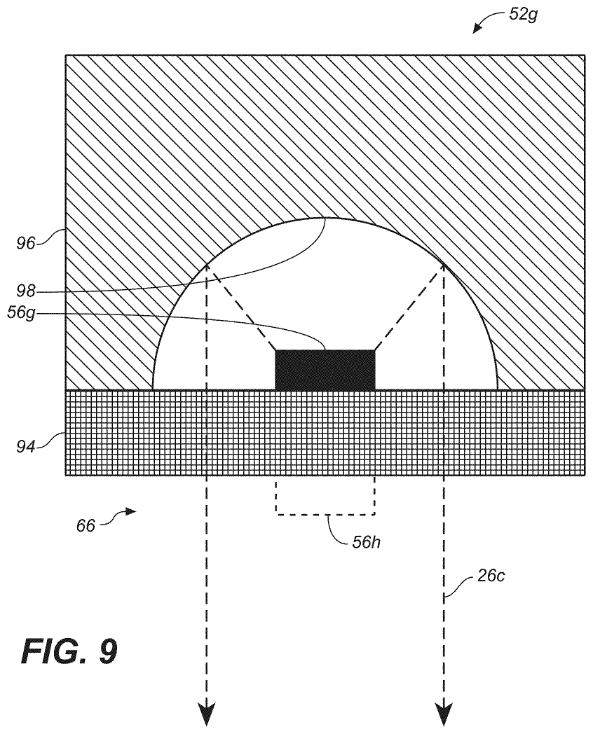

FIG. 9 shows a cross-sectional view of an alternative source array 52g comprising a dish configuration in accordance with the technology of the present description. This configuration incorporates a reflective dish surface 98, rather than lenses 60 shown in FIG. 4 to FIG. 8, to collimate/focus the emitted radiation pattern 26c of each emitter chip 56g. Dish surface 98 may comprise a cylindrical, spherical (or other curvilinear shaped) cross-section having a focal point at the emitter 56g surface, and may be disposed within an elongate member 96 that runs along the length of the array (e.g., the array of emitters 56g are disposed along an axis running into the page in FIG. 9, with material samples being fed left-to-right or right-to-left within imaging region 66). For example, dish surface 98 may be a series of semi-spherical cutouts (e.g., cups) within elongate member 96, or disposed as one semi-cylindrical cutout running along the length of elongate member 96. Instead of an elongate member, the emitters may be positioned adjacent a series of blocks each having a dished surface 98). The emitter chip 56g is disposed on a carrier substrate 94 that may comprise a ceramic PCB, flexible plastic sheet, or like material that allow the free transmission of radiation pattern 26c. The emitter chip 56h may optionally be disposed on the opposite side of the carrier substrate 94, in which the curvature of dish surface 98 is adjusted accordingly so as to have a focal point at the location of the emitter chip. It is also appreciated that the detector array may be similarly constructed, with detector chip (not shown) being disposed in place of the emitter chip 56g or 56h.

In any of the above cases 50a through 50e, a combination of lens elements (and dish emitter/detector configuration 52g shown in FIG. 9) may be incorporated where appropriate.

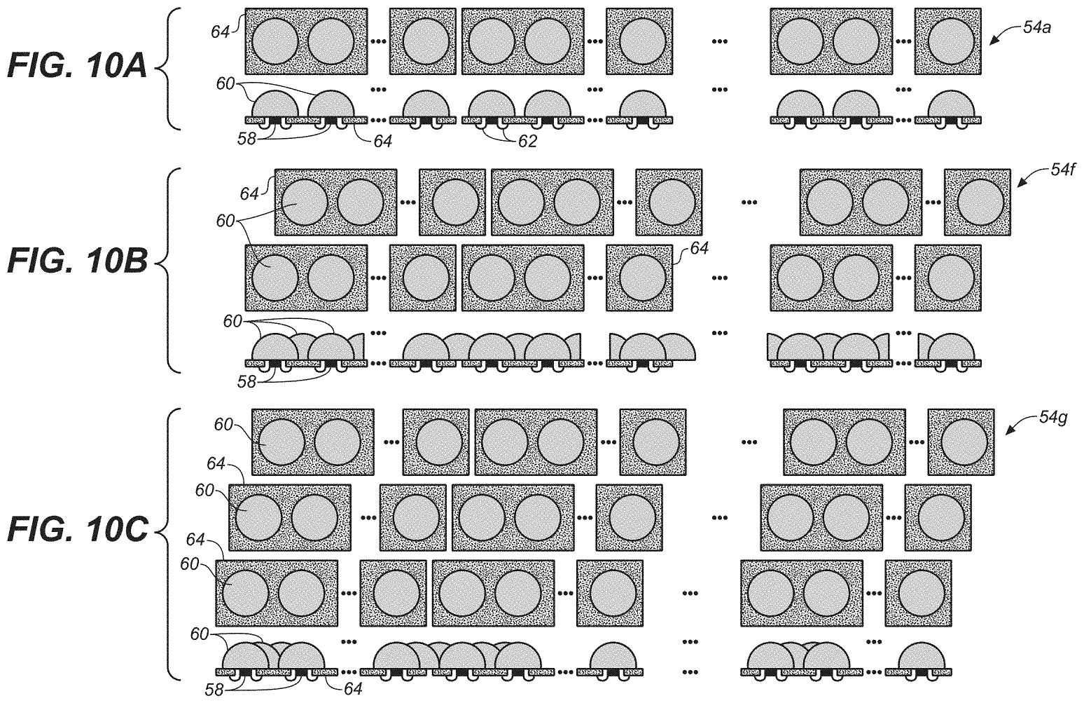

FIG. 10A through FIG. 10C show various detector array configurations used to increase resolution. It is appreciated that while the detector array is shown in FIG. 10A through FIG. 10C, a corresponding source array would mirror the particular configuration in each figure.

FIG. 10A shows an array of detectors 54a disposed as a singular linear array. FIG. 10B shows an alternative array of detectors 54f disposed as pair of interleaved linear arrays. FIG. 10C shows an alternative array of detectors 54g disposed as a series of n interleaved linear arrays.

Additionally, to further enhance the resolution for each lens, more than one pixel can be integrated on the source/detector chip to provide more radiating beams with a finer illumination and imaging resolution.

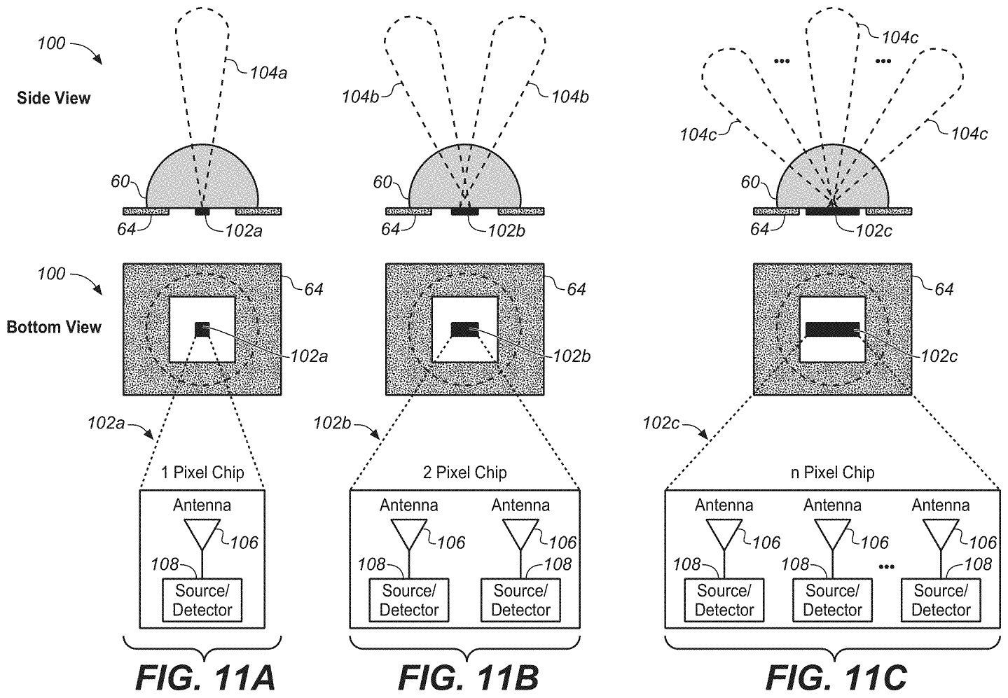

FIG. 11A shows a schematic diagram of an array 100 comprising an individual source/detector chip 102a in the form of a single pixel. Chip 102a comprises an antenna 106 coupled to a source/detector component 108. The antenna 108 emits (for a source) or receives (for detector) a singular antenna pattern 104a through lens 60.

It is appreciated that the source/detector component 108 may comprise various forms known in the art, including, but not limited to, oscillators, transmitters, transistor, or the like devices. Antenna 106 may interchangeably comprise a low-impedance antenna or a high-impedance antenna for the detector chip or source chip.

FIG. 11B shows a schematic diagram of an individual source/detector chip 102b having two pixels. Such two-pixel chip 102b comprises a pair of antennas 106 coupled to respective source/detector components 108. The antennas 108 emit (for a source) or receives (for detector) a dual antenna pattern 104b through lens 60.

FIG. 11C shows a schematic diagram of an individual source/detector chip 102c having n pixels (three are shown in FIG. 11C). This multi-pixel chip 102c comprises n antennas 106 coupled to respective n source/detector components 108. The antennas 108 emit (for a source) or receive (for detector) n antenna patterns 104c through lens 60.

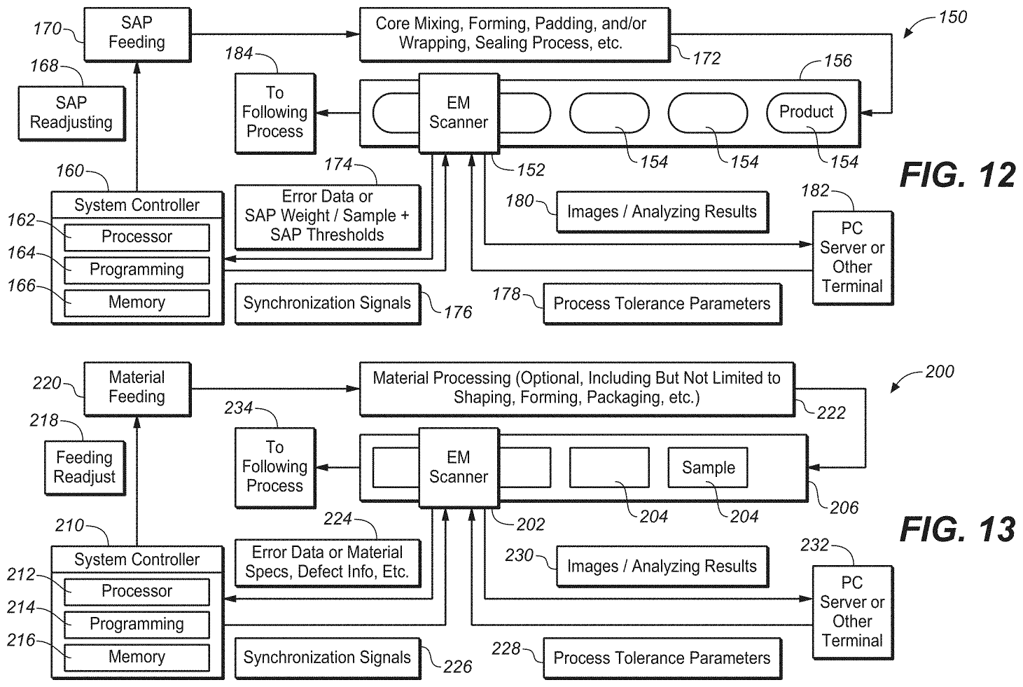

FIG. 12 is a block diagram showing configuration and process flow for an SAP fabrication system 150, with terahertz scanner 152 shown integrated in the fabrication system 150 in a closed loop configuration to support automatic quality control regarding the amount and distribution of SAP within the hygiene product 154. The terahertz scanner 152 is configured to transmit and receive electromagnetic (EM) waves in frequency ranges and configurations of the various embodiments detailed above and shown in FIG. 2A through FIG. 11C.

The terahertz scanner 152 is shown installed at conveyer belt 156 at a location at the desired production process 172 (e.g., where the disposable hygiene product pad 154 is formed and sealed between polyester and polyethylene films, after padding process, or wrapping process, or sealing process, or later process 184).

The process tolerance parameters 178 may be set through a personal computer (PC) 182, or through a server or central control module, programmable logic controller (PLC) or other terminal. Process parameters 178 may include thresholds for SAP over/under doses, distribution factors, defect recognition, etc.

When the fabrication line is in the production process, the terahertz scanner 152 streams out images and values 180 of each sample pad 154 to the PC 182 for the convenience of operator's monitoring. PC 182 may be local or off-site. In the case of the latter, images and analysis results 180 may be encrypted.

Furthermore, the scanner 152 may inform the central control module (system controller 160) by sending error data 174 between the actual scanned values and the preset tolerance parameters, or newly readjusted SAP feeding values. Calculations with respect to error data or newly readjusted SAP feeding values may be performed via programming and processors within the scanner 152, or the scanner may send data relating to SAP weight per sample and SAP thresholds to system controller 160 for processing. For an overdose case, error data=SAP weight per sample−upper threshold value. For an under-dose case, error data=SAP weight per sample−lower threshold value. Alternatively, error data=SAP weight per sample−mean value of upper and lower threshold values. Other calculation methods of error data may also be employed.

The system controller 160 may also return a readjustment control signal 168 to the SAP feeding system 170 for error correction, and synchronization signals 176 to the scanner 152. The configuration of system 150 creates a control loop for automatic adjustment of the SAP.

In a preferred embodiment, the system controller 160 comprises programming 164 stored in memory 166 for executing one or more of the above processes on a processor 162. For example, programming 164 may comprise instructions for an algorithm of error decision, or error-to-feeding correlation, to process the error data and correlate (or map) the error data to the input parameter of the SAP feeding system 170. The calculation of error data and error-to-feeding correlation may also be performed via programming at the terahertz scanner 152 as detailed above. PC 182 may similarly comprise such processing and programming.

In an alternative embodiment, the terahertz scanner 152 may optionally be combined with an optical detector (not shown) equipped with light sources configured to estimate the fluff density and this information with the images and data 180 from terahertz scanner. Such light sources could partially penetrate the core of the hygiene product 154. While SAP is fairly transparent to light, the fluff, however, shows absorption. Combining both optical and terahertz scanned data can give an accurate estimate of the SAP and fluff content of the product core.

While the systems and methods of the technology of the present description are particularly useful for detection and imaging of SAP in hygiene products, it is appreciated the systems and methods may be employed on any number and type of material samples, particularly where the material absorbs and/or reflects terahertz waves. Exemplary materials may comprise, but are not limited to, metals, ceramics, polymers, and inorganic, organic/biological tissues or materials. FIG. 13 is a block diagram showing configuration and process flow for material processing/fabrication system 200, with a terahertz scanner 202 is shown integrated in the fabrication system 200 in a closed loop configuration to support automatic quality control or detection of distribution, density or constituent components with respect to a sample material. The terahertz scanner 202 is configured to transmit and receive electromagnetic (EM) waves in frequency ranges and configurations of the various embodiments detailed above and shown in FIG. 2A through FIG. 11C.

The terahertz scanner 202 is shown installed at conveyer belt 206, and where used for a production item, at a location at the desired production process 222 (e.g., during shaping, forming, packaging, or later process 234).

The process tolerance parameters 228 may be set through a personal computer (PC) 232, or through a server or central control module, programmable logic controller (PLC) or other terminal. Process parameters 228 may include various thresholds for upper and lower limits of a constituent chemical or material quantity, quality, thickness, distribution factors, defect recognition, etc.).

The terahertz scanner 202 streams out images and analysis results 230 of each sample 204 to the PC 232 for monitoring. PC 232 may be local or off-site. In the case of the latter, images and analysis results 230 may be encrypted. Furthermore, the scanner 202 may inform the central control module (system controller 210) by sending error data 204 (or newly readjusted feeding values, material specifications, defect info, etc.) relating to the actual scanned values and the preset tolerance parameters.

The system controller 210 may also return a readjustment control signal 218 to the material feeding system 220 for error correction, and optional synchronization signals 226 to the scanner 202. In this configuration, system 200 optionally creates a control loop for automatic adjustment of the material composition of the sample 204.

In a preferred embodiment, the system controller 210 comprises programming 214 stored in memory 216 for executing one or more of the above processes on a processor 212. For example, programming 214 may comprise instructions for an algorithm for calculation or error data, or error-to-feeding correlation to process the error data generated from the terahertz scanner 202 and correlate (or map) the error data to the input parameter of the material feeding system 220. The calculation of error data or error-to-feeding correlation may also be performed via programming at the terahertz scanner 202. PC 232 may similarly comprise such processing and programming.

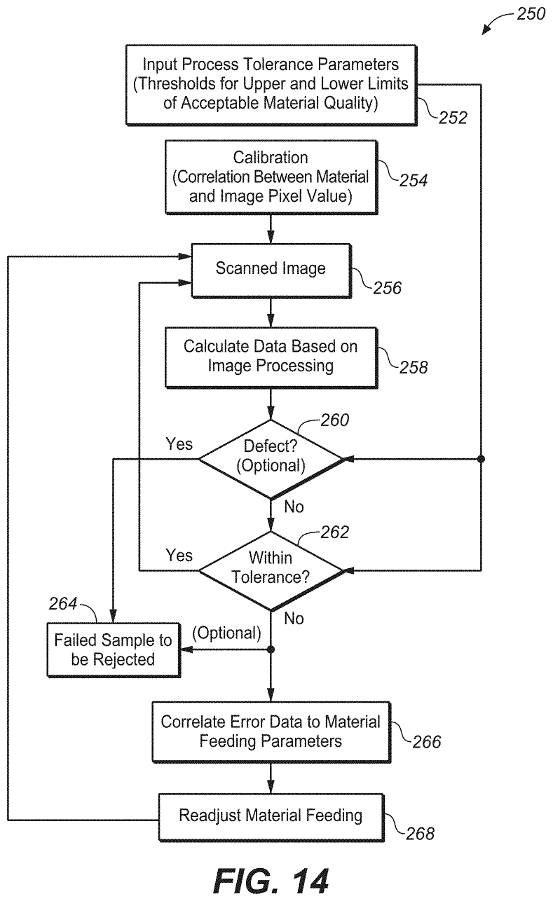

FIG. 14 shows a schematic flow diagram for a material processing algorithm 250 that may be implemented as programming 164/214, all or part of which may be executable on one or more processing devices within systems 150 or 200 (e.g., one or more of the PC 182/232, system controller 160/210 or scanner 152, 202). At step 252, the process tolerance parameters are input. At step 254, a calibration is performed (e.g., correlation between material and image pixel value). An image of the sample is then generated by the scanner at 256. Next at step 258, data is calculated based on image processing from the scanned image at 254.

At step 260, an optional defect query is generated. If a defect is found, the sample is deemed to be a failed item and is rejected at 264. If no defect is found, the system queries whether the sample is within tolerance at step 262. If not within tolerance, the sample may be optionally rejected at step 264, or a correlation of error data to material feeding properties calculation is made at step 266. The material feeding is then readjusted at step 268 for an additional scanning at step 254. If the item is within tolerance at step 262, the item passes and the scanner scans the next sample in line at step 254.

While the systems and methods above are generally configured for a scanner speed of 15 m/s, it is appreciated that higher scanning speeds are contemplated.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general-purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. An apparatus for detection of a composition or attribute of a sample material, comprising: a terahertz wave source comprising a linear array of emitters, each of the emitters being aligned to independently emit a radiation pattern at a specified terahertz wave frequency across an imaging region; a terahertz wave detector comprising a linear array of detectors, each of the detectors being aligned with a respective emitter of the terahertz wave source so as to individually receive the emitted radiation pattern of the respective emitter; wherein the terahertz wave source and terahertz wave detector are disposed adjacent the scanning region so as to allow for passage of a conveyance for moving the sample material through the imaging region; wherein one or more of the emitted radiation patterns are transmitted through or reflected from the sample material for reception by a respective detector in the terahertz wave detector.

2. The apparatus or method of any of the preceding or subsequent embodiments, wherein the linear array of emitters is arranged in a line that is perpendicular to a direction of motion of the sample material.

3. The apparatus or method of any of the preceding or subsequent embodiments, further comprising: a computer processor; and instructions executable on the computer processor; wherein when executed said instructions determine one or more of an amount or distribution of a specified chemical or material of the sample material based on receipt of terahertz wave power received by said terahertz wave detector.

4. The apparatus or method of any of the preceding or subsequent embodiments, wherein when executed said instructions further perform steps comprising: generating an image of the sample material; wherein said image comprises data with respect to the composition and location of the specified chemical or material.

5. The apparatus or method of any of the preceding or subsequent embodiments, wherein the sample material comprises a disposable hygiene product comprising a superabsorbent polymer (SAP), wherein when executed said instructions are further configured to: determine one or more of the amount or distribution of superabsorbent (SAP) material retained within the disposable hygiene product based on absorption of a portion of the emitted radiation from the emitters and corresponding receipt of terahertz wave power received by said terahertz wave detector.

6. The apparatus or method of any of the preceding or subsequent embodiments, wherein the specified terahertz wave frequency ranges from 30 GHz to 10 THz.

7. The apparatus or method of any of the preceding or subsequent embodiments, wherein the specified terahertz wave frequency ranges from 100 GHz to 3 THz.

8. The apparatus or method of any of the preceding or subsequent embodiments, wherein the specified terahertz wave frequency ranges from 300 GHz to 1 THz.

9. The apparatus or method of any of the preceding or subsequent embodiments, further comprising: a lens or dish proximal to each emitter of the linear array of emitters for directing the emitted radiation pattern into the imaging region and sample material.

10. The apparatus or method of any of the preceding or subsequent embodiments, further comprising: a lens or dish proximal to each detector of said linear array of detectors for receiving the emitted radiation pattern after being transmitted through or reflected from the sample material.

11. The apparatus or method of any of the preceding or subsequent embodiments, further comprising: an individual optical element disposed in between one or more of the individual emitter lens and detector lens and the imaging region to collimate or focus the emitted or received radiation pattern.

12. The apparatus or method of any of the preceding or subsequent embodiments, further comprising: a curvilinear lens spanning across one or more of the array of transmitters and array of detectors, the curvilinear lens having a curvilinear sectional profile in a plane aligned in a direction of the emitted radiation pattern and perpendicular to the linear orientation of the array of transmitters and array of detectors.

13. The apparatus or method of any of the preceding or subsequent embodiments, further comprising: a pair of concave and convex lenses spanning across one or more of the array of transmitters and array of detectors.

14.The apparatus or method of any of the preceding or subsequent embodiments, wherein said SAP is distributed within a fluff material, with the combination retained within the disposable hygiene product.

15. The apparatus or method of any of the preceding or subsequent embodiments, further comprising an optical illumination source and corresponding optical detector configured for estimating density of the fluff material in response to determining an amount of optical illumination passing through the disposable hygiene product.

16. The apparatus or method of any of the preceding or subsequent embodiments, wherein when executed said instructions further perform steps comprising: comparing one or more tolerance parameters to the acquired image or data relating to amount or distribution of material; and generating error data relating to the sample material.

17. The apparatus or method of any of the preceding or subsequent embodiments, wherein when executed said instructions further perform one or more of the steps comprising: rejecting the sample material based on the error data; adjusting feeding of specified chemical or material within the sample material based on the error data; and adjusting a material process comprising one or more of mixing, shaping, forming, sealing and packaging the sample material based on the error data.

18. A method for detection of a composition or attribute of a sample material, comprising: disposing a terahertz wave source and terahertz wave detector disposed adjacent a scanning region; the terahertz wave source comprising a linear array of emitters, each of the emitters being aligned to independently emit a radiation pattern at a specified terahertz wave frequency across the imaging region; the terahertz wave detector comprising a linear array of detectors, each of the detectors being aligned with a respective emitter of the terahertz wave source so as to individually receive the emitted radiation pattern of the respective emitter; moving a sample material through the imaging region; emitting the radiation patterns from the emitters such that they are transmitted through or reflected from the sample material for reception by a respective detector in the terahertz wave detector.

19. The apparatus or method of any of the preceding or subsequent embodiments, wherein the linear array of emitters is arranged in a line that is perpendicular to a direction of motion of the sample material.

20. The apparatus or method of any of the preceding or subsequent embodiments, further comprising: determining one or more of an amount or distribution of a specified chemical or material of the sample material based on receipt of terahertz wave power received by said terahertz wave detector.

21. The apparatus or method of any of the preceding or subsequent embodiments, further comprising: generating an image of the sample material; wherein said image comprises data with respect to the composition and location of the specified chemical or material.

22. The apparatus or method of any of the preceding or subsequent embodiments, wherein the sample material comprises a disposable hygiene product comprising a superabsorbent polymer (SAP), wherein the method further comprises: determining one or more of the amount or distribution of superabsorbent (SAP) material retained within the disposable hygiene product based on absorption of a portion of the emitted radiation from the emitters and corresponding receipt of terahertz wave power received by said terahertz wave detector.

23. The apparatus or method of any of the preceding or subsequent embodiments, wherein the specified terahertz wave frequency ranges from 30 GHz to 10 THz.

24. The apparatus or method of any of the preceding or subsequent embodiments, wherein the specified terahertz wave frequency ranges from 100 GHz to 3 THz.

25. The apparatus or method of any of the preceding or subsequent embodiments, wherein the specified terahertz wave frequency ranges from 300 GHz to 1 THz.

26. The apparatus or method of any of the preceding or subsequent embodiments, further comprising: a lens or dish proximal to each emitter of the linear array of emitters for directing the emitted radiation pattern into the imaging region and sample material.

27. The apparatus or method of any of the preceding or subsequent embodiments, further comprising: a lens or dish proximal to each detector of said linear array of detectors for receiving the emitted radiation pattern after being transmitted through or reflected from the sample material.

28. The apparatus or method of any of the preceding or subsequent embodiments, further comprising: an individual optical element disposed in between one or more of the individual emitter lens and detector lens and the imaging region to collimate or focus the emitted or received radiation pattern.

29. The apparatus or method of any of the preceding or subsequent embodiments, further comprising: a curvilinear lens spanning across one or more of the array of transmitters and array of detectors, the curvilinear lens having a curvilinear sectional profile in a plane aligned in a direction of the emitted radiation pattern and perpendicular to the linear orientation of the array of transmitters and array of detectors.

30. The apparatus or method of any of the preceding or subsequent embodiments, further comprising: a pair of concave and convex lenses spanning across one or more of the array of transmitters and array of detectors.

31.The apparatus or method of any of the preceding or subsequent embodiments, wherein said SAP is distributed within a fluff material, with the combination retained within the disposable hygiene product, the method further comprising: directing light from an optical illumination source and corresponding optical detector; and estimating density of the fluff material in response to determining an amount of optical illumination passing through the disposable hygiene product.

32. The apparatus or method of any of the preceding or subsequent embodiments, further comprising: comparing one or more tolerance parameters to the acquired image or data relating to amount or distribution of material; and generating error data relating to the sample material.

33. The apparatus or method of any of the preceding or subsequent embodiments, further comprising: rejecting the sample material based on the error data; adjusting feeding of specified chemical or material within the sample material based on the error data; and adjusting a material process comprising one or more of mixing, shaping, forming, sealing and packaging the sample material based on the error data.

34. An apparatus for detection of superabsorbent (SAP) quantity in a disposable hygiene product, comprising: a terahertz wave transmitter configured for outputting terahertz wave frequencies, a portion of which is absorbed by superabsorbent (SAP) materials; a conveyance for moving a disposable hygiene product through a signal output from said terahertz wave transmitter; a terahertz wave receiver configured for detecting the amount of terahertz wave power which are reflected from, or transmitted through, the disposable hygiene product; and a computer processor and instructions executable on the computer processor wherein when executed said instructions determine the amount of superabsorbent (SAP) material retained within the disposable hygiene product based on receipt of terahertz wave power received by said terahertz wave receiver.

35. The apparatus or method of any of the preceding or subsequent embodiments, wherein said terahertz wave transmitter comprises a plurality of terahertz wave sources arranged in array fashion.

36. The apparatus or method of any of the preceding or subsequent embodiments, further comprising a lens proximal to each of the terahertz wave sources for directing terahertz wave outputs to the disposable hygiene product.

37. The apparatus or method of any of the preceding or subsequent embodiments, wherein said terahertz wave receiver comprises a plurality of terahertz wave detectors in array fashion.

38. The apparatus or method of any of the preceding or subsequent embodiments, further comprising a lens proximal to each of said terahertz wave detectors for directing terahertz waves which have passed through the disposable hygiene product to each of said terahertz wave detectors.

39. The apparatus or method of any of the preceding or subsequent embodiments, wherein said terahertz wave transmitter and said terahertz wave receiver are incorporated within a terahertz wave transceiver configured for both transmission and reception of terahertz waves.

40. The apparatus or method of any of the preceding or subsequent embodiments, wherein said terahertz wave receiver is also configured for imaging the disposable hygiene product by recording both the amount and position of terahertz waves which are reflected from, or transmitted through, the disposable hygiene product.

41. The apparatus or method of any of the preceding or subsequent embodiments, wherein said apparatus further comprises determining the distribution of superabsorbent (SAP) materials in the disposable hygiene product, in response to imaging performed at said terahertz waves and converted to a desired resolution for optical imaging.

42. The apparatus or method of any of the preceding or subsequent embodiments: wherein said apparatus is configured with said terahertz wave transmitter and said terahertz wave receiver positioned on a same side of where the disposable hygiene product is positioned upon a reflective surface that is reflective to said terahertz waves; and wherein terahertz waves from said terahertz wave transmitter are directed to pass through the disposable hygiene product, be reflected from said reflective surface, pass again through the disposable hygiene product, and be received at said terahertz wave receiver.

43. The apparatus or method of any of the preceding or subsequent embodiments: wherein said apparatus is configured with said terahertz wave transmitter and said terahertz wave receiver positioned on opposite sides of where the disposable hygiene product is positioned; and wherein terahertz waves from said terahertz wave transmitter are directed to pass through the disposable hygiene product, and be received on the other side at said terahertz wave receiver.

45. The apparatus or method of any of the preceding or subsequent embodiments, wherein said conveyance comprises a linear translation stage, or conveyor system.

46. The apparatus or method of any of the preceding or subsequent embodiments, wherein said superabsorbent (SAP) material is distributed within a fluff material, with the combination retained within the disposable hygiene product.

47. The apparatus or method of any of the preceding or subsequent embodiments, further comprising optical illumination and optical detection configured for estimating density of the fluff material in response to determining an amount of optical illumination passing through the disposable hygiene product.

48. The apparatus or method of any of the preceding or subsequent embodiments, wherein said disposable hygiene product comprises a baby and adult diaper.

49. The apparatus or method of any of the preceding or subsequent embodiments, wherein said disposable hygiene product comprises a feminine hygiene pad.

50. An apparatus for detection of the amount of superabsorbent (SAP) material in an object, comprising: a terahertz wave transmitter configured for outputting terahertz frequencies which can be absorbed or reflected by a superabsorbent (SAP) material; a terahertz wave receiver configured for detecting the amount of terahertz wave power reflected from, or transmitted through, an object containing a superabsorbent (SAP) material in the object; and a computer processor and instructions executable on the computer processor wherein when executed said instructions determine the amount of superabsorbent (SAP) material retained within the object based on receipt of terahertz wave power received by said terahertz wave receiver.

51. A method for determining the amount of superabsorbent (SAP) material in an object, comprising: exposing an object to terahertz wave power which can be absorbed or reflected by a superabsorbent (SAP) material; detecting the amount of terahertz wave power which is reflected from, or transmitted through, the object; and determining the amount of superabsorbent (SAP) material retained within the object based on detection of terahertz wave power by a terahertz wave detector.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for detection of a composition or attribute of a sample material, comprising:
a terahertz wave source comprising a linear array of emitters, each of the emitters being aligned to independently emit a radiation pattern at a specified terahertz wave frequency across an imaging region;
a terahertz wave detector comprising a linear array of detectors, each of the detectors being aligned with a respective emitter of the terahertz wave source so as to individually receive the emitted radiation pattern of the respective emitter;
wherein the terahertz wave source and terahertz wave detector are disposed adjacent the scanning region so as to allow for passage of a conveyance for moving the sample material through the imaging region;
wherein one or more of the emitted radiation patterns are transmitted through or reflected from the sample material for reception by a respective detector in the terahertz wave detector.

2. The apparatus of claim 1, wherein the linear array of emitters is arranged in a line that is perpendicular to a direction of motion of the sample material.

3. The apparatus of claim 1, further comprising:
a computer processor; and
instructions executable on the computer processor;
wherein when executed said instructions determine one or more of an amount or distribution of a specified chemical or material of the sample material based on receipt of terahertz wave power received by said terahertz wave detector.

4. The apparatus of claim 3, wherein when executed said instructions further perform steps comprising:
generating an image of the sample material;
wherein said image comprises data with respect to the composition and location of the specified chemical or material.

5. The apparatus of claim 3, wherein the sample material comprises a disposable hygiene product comprising a superabsorbent polymer (SAP), wherein when executed said instructions are further configured to:
determine one or more of the amount or distribution of superabsorbent (SAP) material retained within the disposable hygiene product based on absorption of a portion of the emitted radiation from the emitters and corresponding receipt of terahertz wave power received by said terahertz wave detector.

6. The apparatus of claim 1, wherein the specified terahertz wave frequency ranges from 30 GHz to 10 THz.

7. The apparatus of claim 6, wherein the specified terahertz wave frequency ranges from 100 GHz to 3 THz.

8. The apparatus of claim 7, wherein the specified terahertz wave frequency ranges from 300 GHz to 1 THz.

9. The apparatus of claim 1, further comprising:
a lens or dish proximal to each emitter of the linear array of emitters for directing the emitted radiation pattern into the imaging region and sample material.

10. The apparatus of claim 9, further comprising:
a lens or dish proximal to each detector of said linear array of detectors for receiving the emitted radiation pattern after being transmitted through or reflected from the sample material.

11. The apparatus of claim 10, further comprising:
an individual optical element disposed in between one or more of the individual emitter lens and detector lens and the imaging region to collimate or focus the emitted or received radiation pattern.

12. The apparatus of claim 10, further comprising:
a curvilinear lens spanning across one or more of the array of transmitters and array of detectors, the curvilinear lens having a curvilinear sectional profile in a plane aligned in a direction of the emitted radiation pattern and perpendicular to the linear orientation of the array of transmitters and array of detectors.

13. The apparatus of claim 10, further comprising:
a pair of concave and convex lenses spanning across one or more of the array of transmitters and array of detectors.

14. The apparatus of claim 5, wherein said SAP is distributed within a fluff material, with the combination retained within the disposable hygiene product.

15. The apparatus of claim 14, further comprising an optical illumination source and corresponding optical detector configured for estimating density of the fluff material in response to determining an amount of optical illumination passing through the disposable hygiene product.

16. The apparatus of claim 4, wherein when executed said instructions further perform steps comprising:
comparing one or more tolerance parameters to the acquired image or data relating to amount or distribution of material; and
generating error data relating to the sample material.

17. The apparatus of claim 16, wherein when executed said instructions further perform one or more of the steps comprising:
rejecting the sample material based on the error data;
adjusting feeding of specified chemical or material within the sample material based on the error data; and
adjusting a material process comprising one or more of mixing, shaping, forming, sealing and packaging the sample material based on the error data.

18. A method for detection of a composition or attribute of a sample material, comprising:
disposing a terahertz wave source and terahertz wave detector disposed adjacent a scanning region;
the terahertz wave source comprising a linear array of emitters, each of the emitters being aligned to independently emit a radiation pattern at a specified terahertz wave frequency across the imaging region;
the terahertz wave detector comprising a linear array of detectors, each of the detectors being aligned with a respective emitter of the terahertz wave source so as to individually receive the emitted radiation pattern of the respective emitter;
moving a sample material through the imaging region;
emitting the radiation patterns from the emitters such that they are transmitted through or reflected from the sample material for reception by a respective detector in the terahertz wave detector.

19. The method of claim 18, wherein the linear array of emitters is arranged in a line that is perpendicular to a direction of motion of the sample material.

20. The method of claim 18, further comprising:
determining one or more of an amount or distribution of a specified chemical or material of the sample material based on receipt of terahertz wave power received by said terahertz wave detector.

21. The method of claim 20, further comprising:
generating an image of the sample material;
wherein said image comprises data with respect to the composition and location of the specified chemical or material.

22. The method of claim 20, wherein the sample material comprises a disposable hygiene product comprising a superabsorbent polymer (SAP), wherein the method further comprises:
determining one or more of the amount or distribution of superabsorbent (SAP) material retained within the disposable hygiene product based on absorption of a portion of the emitted radiation from the emitters and corresponding receipt of terahertz wave power received by said terahertz wave detector.

23. The method of claim 18, wherein the specified terahertz wave frequency ranges from 30 GHz to 10 THz.

24. The method of claim 23, wherein the specified terahertz wave frequency ranges from 100 GHz to 3 THz.

25. The method of claim 24, wherein the specified terahertz wave frequency ranges from 300 GHz to 1 THz.

26. The method of claim 18, further comprising:
a lens or dish proximal to each emitter of the linear array of emitters for directing the emitted radiation pattern into the imaging region and sample material.

27. The method of claim 26, further comprising:
a lens or dish proximal to each detector of said linear array of detectors for receiving the emitted radiation pattern after being transmitted through or reflected from the sample material.

28. The method of claim 27, further comprising:
an individual optical element disposed in between one or more of the individual emitter lens and detector lens and the imaging region to collimate or focus the emitted or received radiation pattern.

29. The method of claim 27, further comprising:
a curvilinear lens spanning across one or more of the array of transmitters and array of detectors, the curvilinear lens having a curvilinear sectional profile in a plane aligned in a direction of the emitted radiation pattern and perpendicular to the linear orientation of the array of transmitters and array of detectors.

30. The method of claim 27, further comprising:
a pair of concave and convex lenses spanning across one or more of the array of transmitters and array of detectors.

31. The method of claim 22, wherein said SAP is distributed within a fluff material, with the combination retained within the disposable hygiene product, the method further comprising:
directing light from an optical illumination source and corresponding optical detector; and
estimating density of the fluff material in response to determining an amount of optical illumination passing through the disposable hygiene product.

32. The method of claim 21, further comprising:
comparing one or more tolerance parameters to the acquired image or data relating to amount or distribution of material; and
generating error data relating to the sample material.

33. The method of claim 32, further comprising:
rejecting the sample material based on the error data;
adjusting feeding of specified chemical or material within the sample material based on the error data; and
adjusting a material process comprising one or more of mixing, shaping, forming, sealing and packaging the sample material based on the error data.
